(19) United States
(12) Patent Application Publication
(10) Pub. No.: US 2022/0045568 A1
(43) Pub. Date: Feb. 10, 2022

(54) METHOD AND APPARATUS FOR MOTOR COOLING

(71) Applicant: FLUX SYSTEMS PTY LTD, Albany (AU)

(72) Inventor: Timothy McQUOID, Albany (AU)

(21) Appl. No.: 17/436,326

(22) PCT Filed: Mar. 6, 2020
(86) PCT No.: PCT/AU2020/050210

§ 371 Date: Sep. 3, 2021

(30) Foreign Application Priority Data
Mar. 8, 2019 (AU) 2019900771

(51) Int. Cl. H02K 3/24; H02K 3/52; H02K 1/14; H02K 5/132; H02K 5/20

(52) U.S. Cl. CPC H02K 3/24; H02K 3/522; H02K 2213/12; H02K 5/132; H02K 5/20; H02K 1/148

(57) ABSTRACT

For cooling an electric machine having stator windings, a housing including a series of interleading compartments is provided, the compartments being adapted for sealingly and removably enclosing one or more of the stator windings, so that during operation of the machine, a fluent coolant passing through the compartments and immersing the windings removes heat from the windings by thermal conduction. The disclosure has application to electric machines such as electric motors and generators, providing a modularised cooling system for the individual stator windings, allowing each one to be removed if necessary without requiring removal of the whole stator winding assembly.

### CROSS-REFERENCE TO RELATED APPLICATIONS

This application is a national stage entry of PCT/AU2020/050210, filed Mar. 6, 2020, which claims priority to AU 2019900771, filed Mar. 8, 2019, both of which are incorporated herein by reference in their entirety.

### TECHNICAL FIELD

This present disclosure relates to electric machines such as electric motors and generators and to the cooling of stator windings therein. In particular it provides a modularised cooling system for individual stator windings.

### BACKGROUND TO THE PRESENT DISCLOSURE

Electrical equipment such as motors and generators relying on moving magnets to induce current generate heat in their coils. Overheating reduces efficiency and results in long-term degradation or sudden catastrophic failure. There are numerous ways of removing heat from such equipment, cooling fins being but one simple and still widely used example.

Another example involves the use of a fluent coolant to pass over the static coils and remove heat through conduction into the coolant and convective heat transfer from a hotter part of the coolant body to a cooler part.

Immersion cooling is known to be used in high power transformers.

### BRIEF SUMMARY

In describing the present disclosure, the term “motor” will be used for describing the context of it utilisation, but this generic term should be understood also to include other forms of electric machine, for example a generator, as well as any other inductive current-generating device as applicable.

The preceding discussion of the background is intended to facilitate an understanding of the present disclosure. However, it should be appreciated that the discussion is not an acknowledgement or admission that any of the material referred to was part of the common general knowledge in Australia or elsewhere as at the priority date of the present application.

Further, and unless the context clearly requires otherwise, throughout the description and the claims, the words ‘comprise’, ‘comprising’, and the like are to be construed in the inclusive sense of “including, but not being limited to”—as opposed to an exclusive or exhaustive sense meaning “including this and nothing else”.

In addition, use of the “a” or “an” are employed to describe elements and components of the embodiments herein. This is done merely for convenience and to give a general sense of the disclosure. This description should be read to include one, or at least one, and the singular also includes the plural, unless it is obvious that it is meant otherwise.

According to a first aspect, there is provided a method of cooling a electric machine having stator windings, the method including the steps of: providing a housing including a series of interleading compartments, sealingly enclosing one or more of the stator windings removably in the respective compartments, operatively locating the housing in relation to a rotor of the machine, during operation of the machine passing a fluent coolant through the compartments to immerse the windings in the coolant, thereby to remove heat from the windings at least by thermal conduction with the coolant.

In one embodiment, the compartments are operatively arranged in a circular array.

The method may include locating the array radially within the rotor in out-runner configuration.

Alternatively, the method may include locating the array radially externally to the rotor, in in-runner configuration.

In a further embodiment, the method includes passing the coolant in series from one compartment to another in a generally circumferential direction in relation to the rotor.

The method may include the step of causing the coolant to cool.

The coolant may be cooled by passing it through an externally located heat exchanger.

The method may further include providing the compartments as separate electrically non-conductive parts for incorporation into the stator core.

According to a second aspect, a cooling system for an electrodynamic machine includes a plurality of stator windings operatively located in relation to a rotor of the machine, a plurality of sealable compartments interleadingly connected in series, each defined by a wall and adapted for having fluent coolant passing therethrough and for at least one winding to be removably inserted therein in fluid sealing engagement with said wall.

Adjacent compartments may be connected to establish fluid communication between them in said series.

In one embodiment, adjacent compartments are interleadingly connected by means of an aperture in a common wall separating them. However, the compartments may be interleadingly connected by a conduit passing externally from one to another.

In an embodiment, the compartments are arranged in series in a circular array to define a manifold for operative mounting about the rotor.

The compartments may be integrally formed to define the manifold. Formation may be achieved using an additive manufacturing process.

Each compartment may be configured for receiving one winding assembly only.

The containers may alternatively be separately formed and adapted for fitting together so that when the winding assemblies are operatively located therein, they define a stator.

According to a third aspect, there is provided a coolable stator winding assembly adapted for operative arrangement in relation to a stator of an electrodynamic machine, the assembly including a housing defined by a series of interleadingly connected walled compartments and a plurality of core-mounted stator windings,
a. each of the windings being sealingly, removably and operatively located within a compartment,
b. each compartment having a fluid inlet and a fluid outlet, permitting a fluent coolant to pass through successive compartments in sequence to cool the windings when the machine is in operation.

In one embodiment, the fluid outlet is located to align with a fluid inlet on an adjacently locatable compartment for discharge of coolant thereto.

In another embodiment, the core may include a cover plate adapted for sealing engagement with the walled compartment. The cover plate may be integrally formed with the core as a single piece component.

In an embodiment, the assembly compartments are separate, electrically non-conductive parts that are individually removable from the assembly.

The present disclosure extends in a further aspect to provide an electrodynamic machine having a stator, stator windings, and a stator winding cooling system including a series of interconnected compartments:
c. mountable in a circular arrangement in relation to the stator,
d. sealable against coolant loss;
e. adapted for removably receiving the windings in operative orientation, and
f. in fluid communication to allow passage of coolant sequentially along the series from compartment to compartment thereby contacting the windings in heat-transfer relationship.

The windings may be individually removable from the arrangement.

In an embodiment, the compartments are individually removable from the series.

### BRIEF DESCRIPTION OF DRAWINGS

In order that the present disclosure may be readily understood, and put into practical effect, reference will now be made to the accompanying figures. Thus:

FIGS. 1A, 1B, and 1C show in schematic form one embodiment of the coolable winding module of the present disclosure.

FIGS. 2A and 2B show axial and radial views of a motor configured for receiving a plurality of cooling modules in an alternative embodiment.

FIG. 3 is a partially cut-away perspective view of a portion of the system of FIGS. 2A and 2B showing a winding unit operatively inserted in a cooling module.

FIG. 4 is a side view of a complete modular stator arrangement including cooling modules of the embodiment of FIGS. 2A and 2B.

FIG. 5 illustrates in perspective view the inner stator core of FIG. 4 being inserted axially into the outer stator section.

FIGS. 6A and 6B provide side and perspective views of the apparatus of the present disclosure when applied in an example of an out-runner motor configuration.

FIG. 7 is a perspective view of an out-running configuration in which an inner stator section is in the process of being inserted axially into the stator core of FIGS. 6A and 6B.

FIG. 8 illustrates in perspective view an axial flux motor configuration according to an embodiment of the present disclosure in which an unwound axial module is in the process of being axially inserted into a compartment of an axial manifold.

FIG. 9 is an exploded perspective view of a further embodiment showing a stator and housing, the latter having coolant flow paths generated by an additive manufacturing process.

### DETAILED DESCRIPTION

The following description and drawings are illustrative and are not to be construed as limiting. Numerous specific details are described to provide a thorough understanding of the presently disclosed embodiments. However, in certain instances, well-known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present disclosure provides a method of cooling stator windings and is applicable to in- and out-running motors. It may be applied in traction motors, such as may be found in electric vehicles and train motors and in axial-flux motors. However, given the very universal nature of electric motors and their increasingly wide scope of use, the present disclosure is applicable to any drive that requires a high power-density value. This allows for further applications such in as high power-density generators.

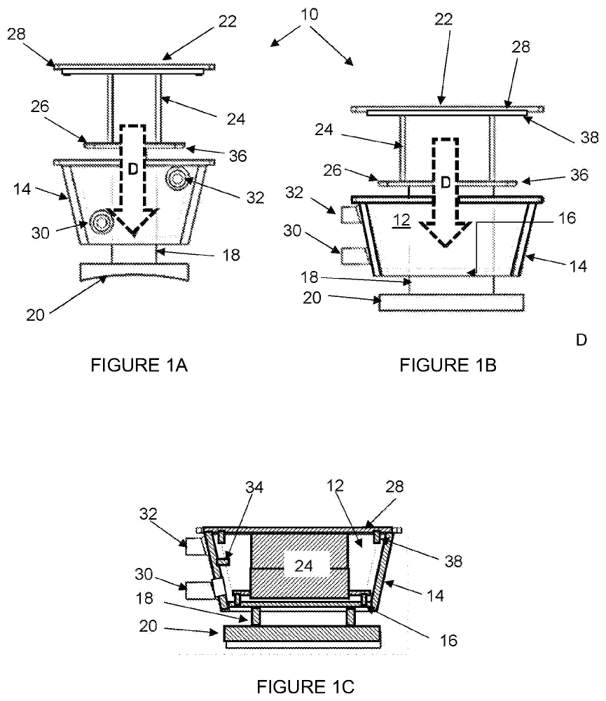

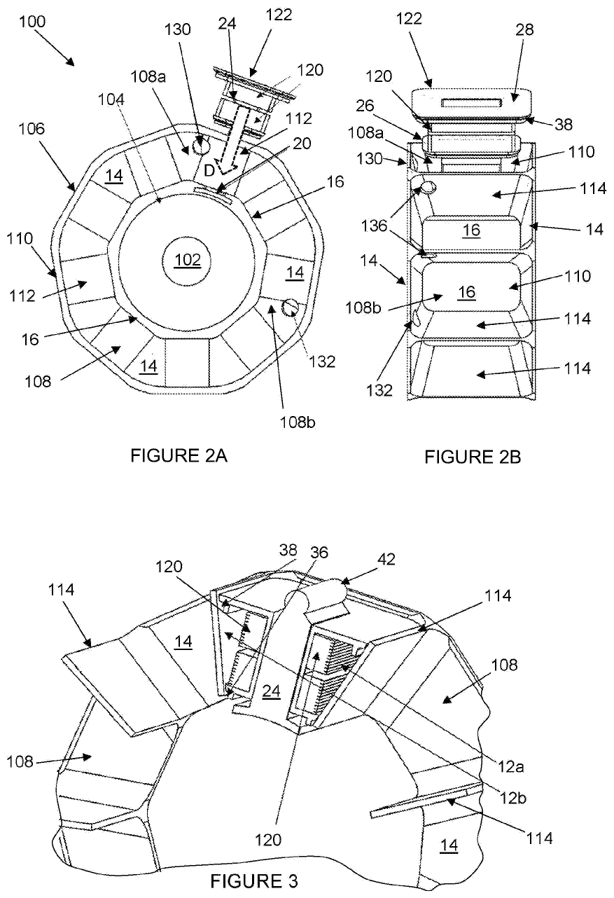

The cooling system described herein may be applied to a sealed coil winding installed in a floodable sealed module. In the embodiment depicted in FIGS. 1A-1C, the module is manufactured as a stand-alone component separately from other like components and a stator assembly but is adapted for mounting radially to a stator core with other like modules. Each module compartment is provided as a separate electrically non-conductive part that is incorporated into the stator core assembly. Each compartment, unless containing sufficient levels of an electrically conductive fluid, is electrically isolated from its neighbour or neighbours. FIGS. 2A and 2B illustrate the module in another form where it is but one of a plurality of sealable containers integrated as a unit into a stator manifold.

In FIGS. 1A-1C, the cooling module in one embodiment of the present disclosure is generally denoted by means of the number 10 and is shown in axial view in FIG. 1A and radial view in FIG. 1B. The module is adapted to be mounted along with other like modules around the circumference of the space occupied by the rotor of an electric motor, such as motor 100 shown in the embodiment of FIGS. 2A and 2B. Mounting is by way of inner and outer stator sections suspending the cooling manifold and modules within. The modules are stationary in relation to the rotatable rotor.

Module 10 provides an open topped, but closeable, containment space 12 defined by walls 14 which surround a floor 16. Walls and floor are integrally formed by a known process, such as moulding or casting. Watertight connections are established at the junctions of the surfaces. The walls slope inwardly towards the floor, so that space 12 is generally wedge-shaped and provides a housing for a winding unit 22 of the stator.

Floor 16 is connected via a connecting element 18 to stator core portion 20.

Winding unit 22 in FIGS. 1A-1C is shown for convenience as a core 24 without the winding operatively applied. Windings of enamelled copper may be used and are wound around the core. Windings other materials may be substituted depending on end applications and performance requirements. The core has at its lower end a base plate 26 and at its upper end a cover plate 28. Each plate has a peripheral sealing ring which comes into sealing engagement with the inwardly sloping walls 14 when the winding unit is operatively inserted into space 12, as indicated by directional arrow D. The core is shown fully inserted (still without windings being shown) into space 12 in FIG. 1(c). It will be noticed that space is available around the windings core. This space is left for allowing fluent coolant to circulate around the windings. The coolant is introduced into space 12 via inlet port 30 and is discharged via outlet port 32. Examples of suitable coolants are known transformer oils and non-conductive fluids having suitable heat capacity at operating temperatures. Depending on coil enamel composition, a water-glycol composition may alternatively be employed. In one embodiment described here, the cover plate is integrally formed with core as a single piece. Formation may be by injection moulding, blow moulding, vacuum moulding or any suitable formation process, including additive manufacturing, for example 3D printing.

In this embodiment, the inlet and outlet ports are located on the same side of the assembly 10. To assist in preventing short circuiting of the fluid between ports 30 and 32 and bypassing the distal side of the windings, a fluid circulation guide in the form of a baffle plate 34 may optionally be added to extend inwardly from wall 14 between the ports. A baffle plate may additionally or alternatively be attached to the windings. In an alternative embodiment, the inlet and outlet may be located on different walls 14, for example on opposite sides of the module.

Seals established with peripheral sealing located around locator rings 36, 38 on the base and cover plates of windings unit 22 ensure the unit remains sealed against loss of coolant. On insertion, core unit 22 is pressed downward into operative position and is held in place by a fastener above it (not shown) that fixes it into space 12 of the manifold, provided by adjacent core stator sections 20. Instead of or in addition to a mechanical fastening, friction fitting may be advantageously employed, using the surfaces of the inner and outer stator sections to hold the unit in position. Alternatively, or in addition, a sealant having an adhesive effect, such as potting sealant, may be used. By such means, alone or in any combination, the core assembly is secured against displacement when the coolant is pumped through the space 12.

The motor 100 of FIGS. 2A and 2B, as is conventional, has an axial shaft 102, on which is mounted a rotor 104. A stator 106 surrounds the rotor and includes a radial manifold defined by a number of radially-arranged compartments 108 separated by common walls 114. The compartments have an outer wall 14 and are open at their radially outer end 110, each defining a receptacle with an internal space 112 for receiving a stator winding insert 122 of the kind shown in FIG. 1. Like numbers depict like components and features. In the unit 122, enamelled copper windings 120 surround core 24. The winding units are pre-wound, ready for insertion directly into the cavity in the manifold, to seal the compartment of insertion against loss of coolant and to immerse the windings in the coolant when pumped through the compartment by an external fluid propulsion device, for example a centrifugal pump.

In this embodiment, the compartments 108 of the manifold arrangement are interleading, with fluid communication between neighbouring compartments being established by communicating apertures 136 in the common walls 114. Coolant is introduced to the manifold via an inlet 130 that provides fluid access to a compartment 108a. Heated coolant is discharged via outlet port 132 located in a different compartment 108b, located angularly remotely from compartment 108a.

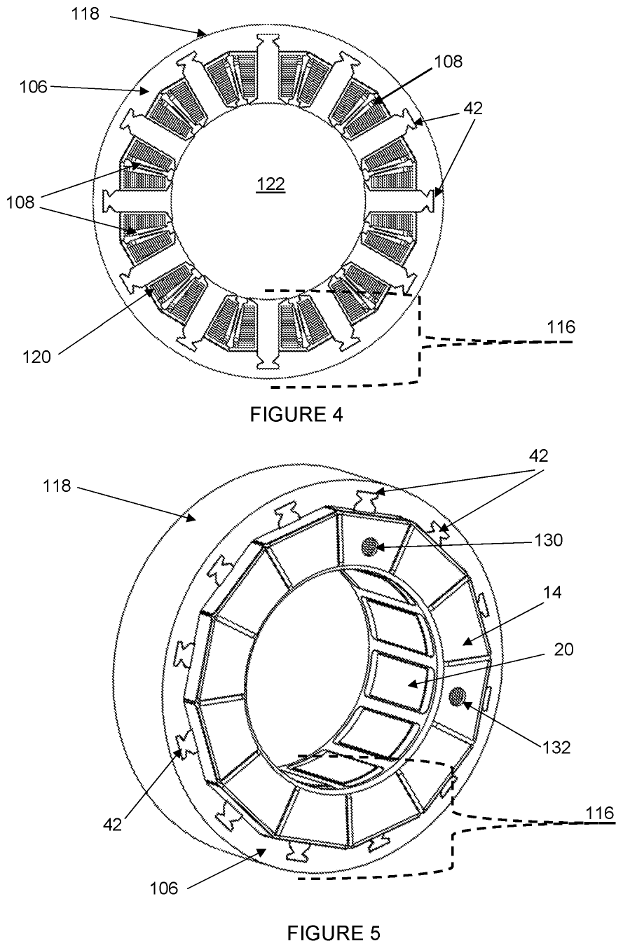

With reference to FIG. 3, a portion of the manifold shown in FIGS. 2A and 2B is shown in sectioned view with a windings unit 122 operatively located in one of the circumferentially arranged compartments 108, which is bounded by side walls 14 and radially-directed shared walls 114. A radially-extending lobe 42 is provided to facilitate secure operative location and connection between the stator core section and the outer stator section 106, shown in the side view of FIG. 4. Together, when connected via the lobe sections, the inner stator core section 116 and outer stator section 106 form the complete stator 118, in what is referred to as a modular stator arrangement. The lobes function to allow the individual modules 122 of the manifold cooling system to be suspended by the inner 116 and outer 106 core sections. As is conventional, the outer stator section, which joins the inner core modules to complete the stator assembly, functions to allow magnetic field flux to pass from one stator to the next. The outer section also provides the interface at which the motor including the complete stator is fixed to its external housing (not shown).

FIG. 5 illustrates in perspective view the inner stator core 116 being inserted axially into the outer stator section 106. Lobes 42 function as locating formations. Complete stator 118, when so assembled, holds the cooling system in place. Outer stator 106 is caused to move axially into place, slotting over inner core lobes 42 to securing location, using a press fit arrangement. In an embodiment, a cover plate may be bolted on to the fitted assembly to stop the possibility of separating movement in the axial direction.

With the winding unit in place, passages 12a, 12b, shown in FIG. 3, are defined on either side of the unit, allowing flow of coolant around it in direct conductive contact with the enamelled copper windings and into the adjoining compartment via an interleading aperture (not shown in this figure) or for the coolant to be discharged from the manifold unit as a whole via outlet port 132. More than one outlet may be provided without departing from the scope of this disclosure. Heat that is transferred into the coolant is then available to be distributed within the coolant by convection.

Having the modules adapted for insertion into the housing, whether that be a separate or manifold housing, allows for the concept of immersed cooling to be applied to in-running, out-running radial flux and axial flux motors, as the housing and module arrangement is easily adapted to suit each configuration.

Although electrical connections of the windings are not discussed, it will be appreciated that they do not contribute to the concept of the system of this disclosure, but will be implemented by conventional means according to standards applicable in the industry. By way of example, the winding modules have a pair of connectable wires protruding from the top section and sealed with a suitable high-temperature sealant.

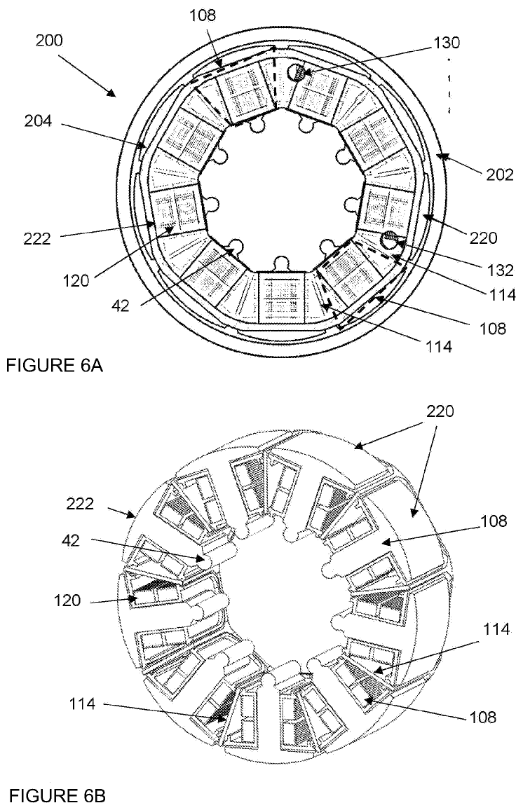

FIGS. 6A and 6B illustrate a further embodiment of the present disclosure, in which a modular cooling system is applied to an out-runner configuration in a stator subassembly 200 having an out-runner stator 202 and stator core 220 including a manifold 204 of individual modular compartments for receiving winding units 222 within the circle defined by the stator. In FIG. 6A, the manifold is illustrated in side view and in FIG. 6B the assembly of units is shown in perspective view with the stator removed. The manifold is divided into compartments 108 by common radially directed walls 114 (of which only a couple are shown by way of example). In FIG. 6A, a compartment 108 is represented generally by broken dashed lines. It lies between shared dividing walls 114 separating it from its immediate neighbouring compartments.

In this embodiment, the winding units have connector lobes 42 located radially inward instead of outward as was shown in FIG. 3. Like or equivalent parts carry like numbering, for example coolant portals 130, 132, winding coils 120 and winding units 222.

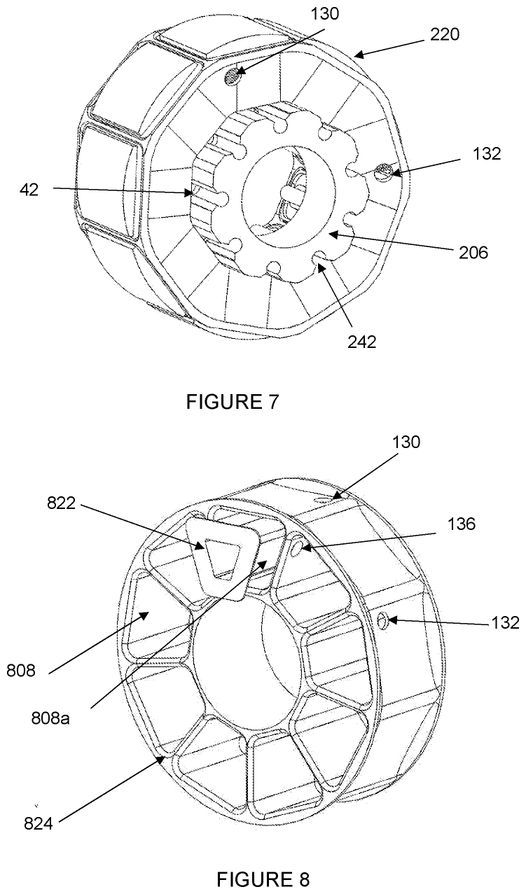

FIG. 7 is a perspective view of an out-running configuration in which an inner stator section 206 is in the process of being inserted axially into the stator core 220 of FIGS. 6A and 6B. Section 206 has circumferential concavities 242 that matingly slide along lobes 42 to engage the respective stator sections.

The heated coolant discharged from the overall stator assembly may be passed through a cooler, such as a finned heat exchanger mounted on or adjacent the motor or other electrodynamic machine in which the system of this disclosure is incorporated. Cooled coolant is then returned to the stator assembly as previously described.

FIG. 8 illustrates the system of this disclosure being applied to an axial flux motor configuration, in which an unwound axial module 822 is shown in the process of being axially inserted into a compartment 808a of an axial manifold 824, to create the equivalent internal cavity 808 as found in the radial examples of the previously-described embodiments. Coolant runs through each compartment, in contact with the coils (not shown) within the modules such as module 822.

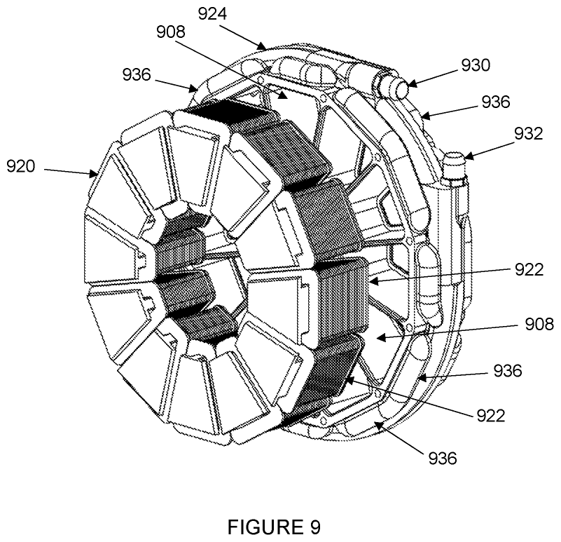

Referring to FIG. 9, a removable subassembly of winding units 920 is shown withdrawn from a stator manifold 924 into which it is fits in operative configuration. The entire manifold shown here may be manufactured using an additive manufacturing method, such as 3-dimensional (3D) printing. As described in relation to other embodiments, the winding units 920 have windings 922. The webbing that makes up the formed manifold has been 3D printed to produce as a single, integrally formed piece, the relatively complex geometrical forms that define interleading winding-receiving compartments 908 with in-built coolant passages and the fluid flow conduits that connect them. The compartments are in fluid communication by virtue of interleading external radially-formed conduits 936. The conduits to and from the compartments define a continuous flow path for coolant from an inlet 930 to an outlet 932. A 3D-printed housing may likewise be beneficially generated for accommodating the radial interleading concept of arrangement of the winding modules.

Advantages that the system of this disclosure contributes over the current state of the art include without limitation:
a. an increased rate of cooling being achieved due to a greater wetted and interacting surface area between the coils and coolant fluid,
b. direct thermal contact between coils and a liquid coolant, promoting conductive and convective heat transfer in preference to indirect cooling mechanisms, and
c. availability of less complex and cost-effective manufacturing techniques than those required for indirect cooling systems.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality that are presented as a single component may be implemented as separate components. These and other variations, modifications, additions, and improvements lie within the scope of the invention being claimed.

Certain embodiments are described to include a number of components, motors, or mechanisms, for example, as illustrated in FIGS. 2A, 2B, 3 and 4. It is to be appreciated that not every component part need be mentioned, let along exhaustively described for a skilled reader to understand the invention, its working and its scope.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Upon reading this disclosure, through the principles disclosed herein, those of skill in the art may appreciate additional alternative structural and functional designs for a system of modularised cooling units for windings. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method of cooling an electric machine having stator windings, the method comprising:
providing a housing comprising a series of interleading compartments;
sealingly enclosing one or more of the stator windings removably in the respective compartments;
operatively locating the housing in relation to a rotor of the machine; and
during operation of the machine passing a fluent coolant through the compartments to immerse the windings in the coolant, thereby to remove heat from the windings by thermal conduction with the coolant.

2. The method of claim 1, wherein the compartments are operatively arranged in a circular array.

3. The method of claim 2, including locating the array radially within the rotor.

4. The method of claim 2, including locating the array radially externally to the rotor.

5. The method according to claim 1, further comprising passing the coolant in series from one compartment to another in a generally circumferential direction in relation to the rotor.

6. The method according to claim 1, further comprising providing the compartments as separate electrically non-conductive parts for incorporation into the core of the stator.

7. A cooling system for an electrodynamic machine comprising a plurality of stator windings operatively located in relation to a rotor of the machine, a plurality of sealable compartments interleadingly connected in series, each defined by a wall and adapted for having fluent coolant passing therethrough and for at least one winding to be removably inserted therein in fluid sealing engagement with said wall.

8. The cooling system of claim 7, wherein the compartments are arranged in a circular array to define a manifold for operative mounting about the rotor.

9. The cooling system of claim 8, wherein adjacent compartments are fluid-communicably connected by means of an aperture in a common wall separating them.

10. The cooling system according to claim 7, wherein the compartments are separate electrically non-conductive parts mountable on the stator core.

11. The cooling system according to claim 7, adapted for the coolant to pass in series from one compartment to another in a generally circumferential direction in relation to the rotor.

12. A coolable stator winding assembly adapted for operative arrangement in relation to a stator of an electrodynamic machine, the assembly comprising a housing defined by a series of interleadingly connected walled compartments and a plurality of core-mounted stator windings,
a. each of the windings being sealingly, removably and operatively located within a compartment,
b. each compartment having a fluid inlet and a fluid outlet, permitting a fluent coolant to pass through successive compartments in sequence to cool the windings when the machine is in operation.

13. The coolable stator assembly of claim 12, wherein the fluid outlet is located to align with a fluid inlet on an adjacently beatable compartment for discharge of coolant thereto.

14. The coolable stator assembly of claim 12, wherein the core comprises a cover plate adapted for sealing engagement with the walled compartment.

15. The coolable stator assembly of claim 14, wherein the cover plate and the core are a single piece.

16. The coolable stator assembly according to claim 12, wherein the compartments are separate electrically non-conductive parts individually removable from the assembly.

17-23. (canceled)
